(19) United States
(12) Patent Application Publication
(10) Pub. No.: US 2008/0294667 A1
(43) Pub. Date: Nov. 27, 2008

(54) METHOD OF COMMUNICATION FOR DATA TRANSFER TO AN ELECTRONIC MICRODEVICE

(75) Inventor: Daniel Kopf, Roethis (AT)

Correspondence Address: Muncy, Geissler, Olds & Lowe, PLLC, P.O. BOX 1364, FAIRFAX, VA, 22038-1364, US

(73) Assignee: Daniel Kopf, Roethis (AU)

(21) Appl. No.: 12/062,329

(22) Filed: Apr. 3, 2008

Related U.S. Application Data
(60) Provisional application No. 60/909,764, filed on Apr. 3, 2007.

(30) Foreign Application Priority Data
Feb. 25, 2008 (EP) EP 0 810 194 1.6

(51) Int. Cl. G06F 17/30; G06F 15/16

(52) U.S. Cl. 707/101; 709/201; 707/E17.009; 707/E17.01

(57) ABSTRACT

In a method of communication for the transfer of data for an electronic microdevice (1) using a user interface realized in a display device (2) for the representation of data of the microdevice (1) by means of a script-based browser that retrieves files as units of information from within a script, and by means of a data transfer protocol, a middleware (4) is used. This middleware (4) has on the one hand a first communications link (EK) to the display device (2) and on the other hand a second communications link (ZK) to the microdevice (1), the rate of data transfer in the second communications link (ZK) being lower than that in the first communications link (EK), and the computing power and memory of the microdevice (1) being lower than the computing power and memory of the middleware (4). The method transfers data assigned to the microdevice (1) to the display device (2) via the middleware (4), while data from the microdevice (1) are transmitted for transfer to the middleware (4), synchronously or asynchronously in advance. In this process the data to be transferred are adapted in such a way that the middleware (4) provides a file that is specific to the microdevice (1) and to the display device (2), and this specific file can be associated with the microdevice (1) by the display device (2) by virtue of the file designation, so that a processing by means of script-based browser becomes possible and the middleware (4) defines for the display device (2) the functional interface to the microdevice (1).

The invention relates to a method of communication for data transfer to an electronic microdevice according to the preamble of claim 1, to a computer program product, and to a data structure product.

At present, increasing demand is felt for including and integrating the largest possible number of electronic devices into a common communications network, so that access to the data of the devices thus connected, as well as remote control of such devices becomes possible. It will be advantageous to retain for future use the familiar technologies, surfaces, and interfaces already introduced. While it is relatively easy to include devices having marked computing power and the corresponding memory and use widely known protocols such as TCP/IP or HTTP, the system requirements associated with such protocols constitute a problem for electronic microdevices having low computing power, scarce memory, and low rates of data transfer.

Yet, including such devices into local networks or into global networks such as the Internet, would provide users with basically worldwide access to such devices, e.g., for remote control of domestic appliances from a vacation resort A need exists, therefore, to include even microcontroller-based microdevices into existing communications systems, and to be able to operate them like a kind of webserver, despite their memory limitations and despite the low rates of data transfer. It should then become possible to connect these microdevices with display devices such as a PC, mobile devices, webpanel PC, media TV, etc., so that a generic browser existing in these display devices could provide a display of the user interface of the device, such as a graphical user interface (GUI), thus making a remote operation of the microdevice possible. It should not be required to install any device-specific software in the display devices, in order to secure a universal facility for inclusion, and compatible microdevices would be recognized automatically.

Networking technology for electronic microdevices should then wherever possible have the following characteristics:
device operation via Graphic User Interfaces (GUI), wherever possible from any display device such as PC, mobile devices, webpanels, TV.
suitability for microdevices having memories and data transfer rates not high enough for known HTTP and/or TCP/IP protocols.
remote control via the Internet, again from a diversity of display devices and while observing high data security.
installation of device-specific software on a display device or router should not be required.
microdevice control even without an active Internet connection.
suitability for microdevices of any kind, no limitation to a specific group of devices.
wide applications spectrum in the operations.
recognition of devices and transparent representation of the devices connected.
possibility of including device functions into online web applications.

Purely by way of example, some generic microdevices and their applications will be listed in the following.
A wristwatch (e.g., a sports wristwatch with heart rate monitor) is connected with a display device (PC or mobile phone, etc.), its contents are displayed in a browser on the PC, and the watch may be operated and set via this browser without installing an application that would have to be developed specifically for this wristwatch. The connection could be via RFID technology, NFC, or a cable, for instance.
A pedometer (sports accessory to be put into a shoe, see nike.com for example) obtains data from, and transfers data to, a mobile phone (or PC) via wireless communications technology.
Using the technology presented here, a measuring device offers results it has obtained in the browser of a connected display device, so that these results may be displayed without installing any device-specific software in the display device. Operating commands of the user are accepted by the measuring device via this browser surface.
A set-top box or media-center PC (with TV display screen) shows the device GUIs (such as pages for setting, pages for the selection of programs, contents, and settings) on a mobile device with browser (or on a PC or other operating console that is browser-compatible).
The set-top box (STB) or media-center PC together with the TV screen are themselves the display device, the middleware (4) explained below runs in the STB so that microdevices connected with the STB may be operated in the browser also running in the STB and seen on the TV screen.
A stereo system is displayed on a mobile phone or on an operating console (or mobile phone, PC, etc.) specifically conceived, or its setting screens appear on such display devices.
A non-contact automatic door opener based on RFID, ZigBee, or Bluetooth as the radio communications technology shows its contents such as access rights and logged access data in the browser of a mobile phone (or PC, etc.), and may also be operated via this surface.
A service technician in his function services a device, such as a drinks dispenser, reads values (that is, variables), and makes settings (that is, assignments of variables).
The owner of a device loads firmware/software upgrades down into the device without any specific software.

Methods are known in the prior art which certainly can be used to operate microdevices via PC. This is even true for particularly small devices such as sports watches, sphygmomanometers, multimeters, etc. They have in common, however, that device-specific software must be installed for each of the devices on each of the display devices. When a newer device model has been acquired, in most cases a new software installation is required. Similarly, when a new display device (PC) has been acquired, then for each of the devices, the software must be reinstalled. This software installation usually is done via a CD delivered with the device, or via an online page with download, and requires a number of steps. Apart from the applications software proper, device-specific drivers (that is, hidden software) must also be installed in many cases. This requirement is a deterring obstacle for large part of the PC users, and is demanding even for well versed users.

Particularly for devices having a small microcontroller (<100 kB memory, 8 bit computing power or lower), it looks as if these requirements for an integration without the installation of device-specific software components could not be satisfied, for the following reasons in particular:
Commonly, memory of several tens of kB is cited, as well as a recommended computing power in excess of 8-bit, in order to implement TCP/IP and HTTP. This is even more relevant in cases where the 8-bit processor is busy with the functions of its own device.
Large possibilities for uses of applications running in a browser or rely on scripts such as Ajax have memory needs distinctly in excess of 100 kB when counting the common Ajax/JavaScript libraries, which is unrealistic for small microcontrollers, and in addition would need an inacceptably long time for data transfer via a slow dataline.
A webserver functionality as a rule needs a file server implementation or similar provision in the microdevice, again consuming resources.

It is the aim of the present invention to provide a method for improved or simplified communication with electronic microdevices.

It is a further aim to enable inclusion of such microdevices into communications systems without the need for any device-specific adaptation on the user side.

It is a further aim to enable remote control of microdevices via communications networks such as the Internet or via LAN or WLAN.

According to the invention, these aims are attained by the subject matter of claim 1, they are also attained or solutions developed by the characterizing features of the dependent claims.

The invention relates to a method of communication for data links with an electronic microdevice. According to the invention, a computing unit is included as middleware between the microdevice and the computer used to realize the user interface. This middleware acts as an intermediate layer, handles requests directed to the microdevice, and where applicable adapts data to be transferred in this context, by changing or supplementing them. This middleware then acts as the interface between browser and microdevice, in such a way that seen from the browser, a virtual functional unit has been created that has a higher level of performance than the microdevice.

The script-based browser uses data input from so-called “scripts” and from files, and files containing data to be used are retrieved while working through the scripts. These two elements thus embody content, structure, and style of the user interface. The scripts are text-based at least in part, and can be read by people in a simple text editor. The approach according to the invention consists in providing the settings and data that are specific to the microdevice, by the microdevice via the middleware, and procuring the retrieval via a file designation assigned to the microdevice, such as a file name or commented entry. Communication commonly starts by a query concerning a so-called default file such as index.html. The browser thus accesses (such) a file that is transported via the middleware or is provided by the middleware, which assumes all additional functions required to secure interoperability. This holds true more particularly for the compression or decompression of files, for supplementing data to be transferred to the browser, and for handling communication with the microdevice.

The functions and files or libraries specific to the microdevice thus are provided by the middleware acting in the background, and able to access preinstalled, fixed or static sets of data as well as external resources provided dynamically via communications systems. Naturally, various other variants including, e.g., a periodic local download of data resources updated and provided via the Internet or via a LAN, are possible.

Commonly, networks are characterized in terms of the OSI model where the individual functions of a data communications link are divided into seven different categories or layers. The well-known Hypertext Transfer Protocol (HTTP) then refers to the application-oriented three top layers. In layers below, TCP and IP are found. The user or software application proper is located as the application layer above the uppermost protocol layer No. 7. In the following, the specific common case will be considered where HTTP is used as the protocol for the transfer of (HTML) files and where these. (HTML) files are represented in a browser. Within the HTML file, further files may then be requested that are needed for display (e.g., image files) or script processing (e.g., a JavaScript file or Flash file). Ordinarily, in a HTML file only the uppermost layer of the HTTP protocol may be addressed (requesting a file by file name), but not the layers beneath. Access to layers beneath is not possible in HTML, while in JavaScript additional input (i.e., additional lines of code) is needed and may lead to errors. In the approach according to the invention, the microdevice preferably is limited to making a file request by file name, in order to save resources, so that for the purposes of caching, the unique file identification should preferably be contained in the file name. This understanding is relevant for the concept of caching according to the invention that is presented below.

It is made possible by the invention, in particular, to link microdevices that are particularly small and have data transfer rates and memories distinctly smaller than those found in PCs and mobile phones, with display devices and more particularly with PCs, mobile telephones (particularly the so-called “smart phones”), mobile devices having a browser with Ajax and/or Flash capability, and television sets (possibly provided or connected with a so-called set-top box that can establish a connection with the Internet or even with the microdevices). It is also made possible by this invention that those microdevices not normally having an Internet connection, may comfortably communicate with the user via display devices. It is an essential part of the invention, finally, to provide each of these devices with a user interface via a browser that is present as a standard, and that has Ajax capability, that is, will understand JavaScript as well as “asynchronous JavaScript and XML” (=Ajax) in addition to HTML. The XMLHttp request enables an asynchronous reloading (that is, reloading occurring in the background) of data such as the files illustrated below that contain data in an xml oder json format, and subsequent updating at the intended place in the browser without the need for a reloading of the full page (as in HTML).

The technology presented here is particularly powerful in the context of microdevices having particularly small chips, e.g., 8 bit chips having 100 kB of memory or less. In such microcontrollers, the so-called web server technology is certainly known, but as a rule it merely provides static representations offering relatively small operating comfort, as they rely on HTML exclusively. The prior art does not realize a dynamic check of data present in the microdevice that occurs in the background, or their representation in the browser. According to the invention, it will be quite possible instead of the Hypertext Markup Language (HTML), to implement even in such small microcontrollers Ajax script language that has since become dominant in the web design field, while limitations to be expected on account of limited memory and low data transfer rates, and last not least even on account of limited computing power, will now be overcome.

It becomes possible in this way to link small microprocessors with a browser, and where applicable with the Internet as well, without having to realize a full TCPIAP protocol on this small processor. This approach would actually be advantageous where the processor has a higher computing power. Thus, it is quite common to use a 32-bit processor for TCP/IP applications. Larger processors cannot be used, however, in applications where device dimensions, price, and power consumption are dominant considerations, and the smallest possible microcontrollers are needed.

According to the invention, moreover, a specific syntax is suggested for server-side includes, that is, a syntax for a dynamic inclusion of values of variables into script pages, and at the same time a syntax for the assignment of variables is specified that enables an early development of (Ajax or HTML) scripts and their continued testing on a simulation web server specifically adapted. In addition, a very simple and transparent interface between device developer and Ajax script designer (web designer) is made possible. In this way project execution becomes simpler and more transparent, project duration is shortened, and success of the project more likely.

According to the invention, the following data structures and principles of data transfer are used, either individually or cumulatively in the context of device communication:
A data caching mechanism controlled at the request level above the 7th OSI layer, by inserting a hash value into the URL or into the file name. This concerns all static files but does not concern any files having dynamically variable contents. Because of its simplicity and perspicuity, this mechanism is suitable for microdevices. Because of its simplicity, this mechanism can also be implemented and efficiently executed on low-power platforms (such as router platforms).
Adapting the data structure to microdevices: For microdevices having a particularly low performance, a web server data structure is set up that consists of two files only: on the one hand a default file (e.g.,/index.html or /), and on the other hand a zipped file containing all other (static) script files that may for example be called “device.zip”. The middleware then functions by inquiring about the file “device.zip”, automatically for example, it unzips the contents, and responds to these files directly when receiving an inquiry without redirecting this inquiry to the device. It is an essential advantage of this data structure that seen from the browser, a microdevice looks like a web server having numerous files, but in its practical realization needs to know and store only two files. In this way this microdevice needs no file system and can still function like a web server, so that microcontrollers having even fewer resources may become web miniservers. It is assumed here that this device will always be connected via middleware taking up the functions of inquiry, unzipping, and providing the contents of this zipped file “device.zip”. Thus, in favor of the microdevice, the computing work is redistributed to the middleware which commonly runs on platforms that are relatively more powerful. Dynamic contents may preferably be offered in the form of syntactically specified variable scripts (or the like), e.g., in the form of .json files embodying a data structure that relative to xml files is compact, yet transparent and readable by humans. These are not necessarily part of the file system but are processed by preinstalled functions of the firmware in the microdevice, so that the file system may be kept small.
Simplification of the data transfer protocol on the side of the microdevice: the middleware accepts inquiries from the browser, e.g., based on the well-known HTTP protocol, and answers them. However, many other protocols used in Internet data traffic can be considered: HTTPS for secure data communication, UDP, SIP, etc., also wireless transfer protocols such as the serial-port profile of Bluetooth, ZigBee, IEEE 802.15.4, etc. For microdevices, however, these protocols need too many resources, so that a direct processing by the microdevice in the current state of the art is impossible. According to the invention, the protocol such as, for example, http is strongly simplified, and a protocol similar to HTTP is designed into which only a subset of the protocol is included and used for the communication between middleware and the microdevice. In short, in the instance of HTTP, the following are included from HTTP:
   only one request line, no further HTTP lines
   syntax of the request (e.g., “GET . . . ”, “PUT . . . ”)
   syntax for the transfer of values of variables analogous to that for the transfer of request parameters (e.g., “GET . . . ?VAR1=1”)
   syntax of the response without any HTTP status lines, at most with one line (particularly when only a HTTP status code is sent as the response (“OK” for the PUT command or “not found”, see below)
   syntax of the response to regularly requested data files (e.g., from sensors) with a HTTP line preceding the content that specifies a period of validity of this data file and tells the middleware that this file may go to intermediate storage. Contrary to the known HTTP entry “expires: . . . ”, here the microdevice specifies a relative duration, e.g., in milliseconds, rather than an absolute time, so that this information need not be computed in the microdevice (i.e., it is static) and no current time need to be known. This means that the middleware may provide for intermediate storage of this specific file for the given duration when the browser asks for exactly this file in exactly this specific device, no matter which browser sent the request. This also means that the device is not overloaded with inquiries when serving a number of browsers in parallel. This HTTP entry preceding the content of a data file may be made a fixed part of the file at the start of the file, from the viewpoint of the microdevice, while recognition by the middleware is through “HTTP . . . ” at the start of the file, which tells the middleware that a HTTP header line is present. As is common in http, the http header line is separated from the content that follows, by <CR><LF><CR><LF>. Example:
      HTTP/1.0<CR><LF>
      Expires: 1000 ms<CR><LF><CR><LF>
      {“SENSORVALUE”:“25° C.”}
   An indication of length of the content as specified by HTTP is omitted so that the microdevice need not count the length of the content in advance and provide this length, as required in HTTP. The length is calculated by the middleware and inserted into the corresponding HTTP line. In this way again the microdevice is relieved of an activity requiring computing power, particularly so when contents are dynamic.
   Terminating a request with an End-Of-File, preferably 0x00, that is, zero, which is an advantage later on when implementing in JavaScript, since 0x00 is also used there to recognize the end of a string in the case of string variables having content, so that the same escape rules can be used, particularly so also with the PUT of online data. Escape rules for the data content so that the End of File will not appear inside the content but unambiguously only at the end of the response, and thus only once within the request/response cycle, viz., at the end of this cycle. This EOF-related data communication is particularly suitable for serial data transfer, even In cases where several microdevices all having low computing power are hooked up to a serial bus, since the end of a request/response transmission can simply be recognized by EOF.

Modifications of this solution that are made in accordance with the invention can be implemented by one skilled in the art, for other protocols and system requirements as well, the basic principle of relieving the microdevice in matters of protocol syntax, computing work, and data transfer requirements being retained. The protocol may be defined more particularly as a genuine subset of HTTP. This can be achieved by inserting in each case the HTTP line “content length:[length]” in front of the HTTP content, rather than attaching EOF at the end.

Many connections come about via a USB adapter. The middleware could be present in such a USB adapter with memory function, so that it is available automatically without any prior installation (“software cable”). This USB adapter then serves in a double function: it stores the middleware (USB memory stick) and it also contains a signal adapter, e.g., from USB to a serial data cable (RS232, RS485, RS422 or the like), from USB to ZigBee (ZigBee coordinator function), from USB to UWB, etc.

The invention offers particular advantages in a technical constellation such as that pictured above, but it is not limited to it. Thus, it can be applied without limitations to the connection of all possible small devices.

The invention, and more particularly the easy-to-handle caching mechanism, can further be used as well out of the context of microdevices, in the Internet and in web applications, to take care of reliable caching of files uniquely identified by their file names, that is, of a caching of files and more particularly of common library files independently of browsers and URL, as well as to prevent the reloading of such files.

Such a function can be made a fixed part of the browser (also as a plugin, for example), so that the middleware need not be started separately. It can also be solidly integrated into the operating system or started automatically when starting the operating system.

The method according to the invention will be described or explained in greater detail, purely by way of example in view of the embodiments represented schematically in the drawings. Individually shown are in

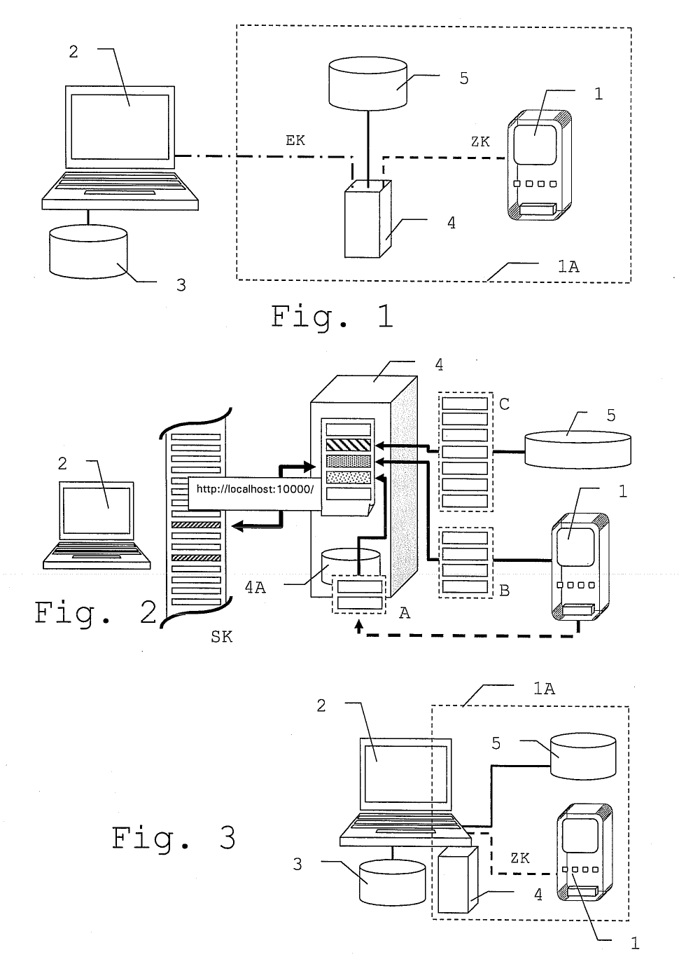

FIG. 1 a schematic representation of the basic principle of the method of communication according to the invention;

FIG. 2 a schematic representation of data retrieval by the browser of the user interface;

FIG. 3 a schematic representation of a first embodiment of the method of communication according to the invention;

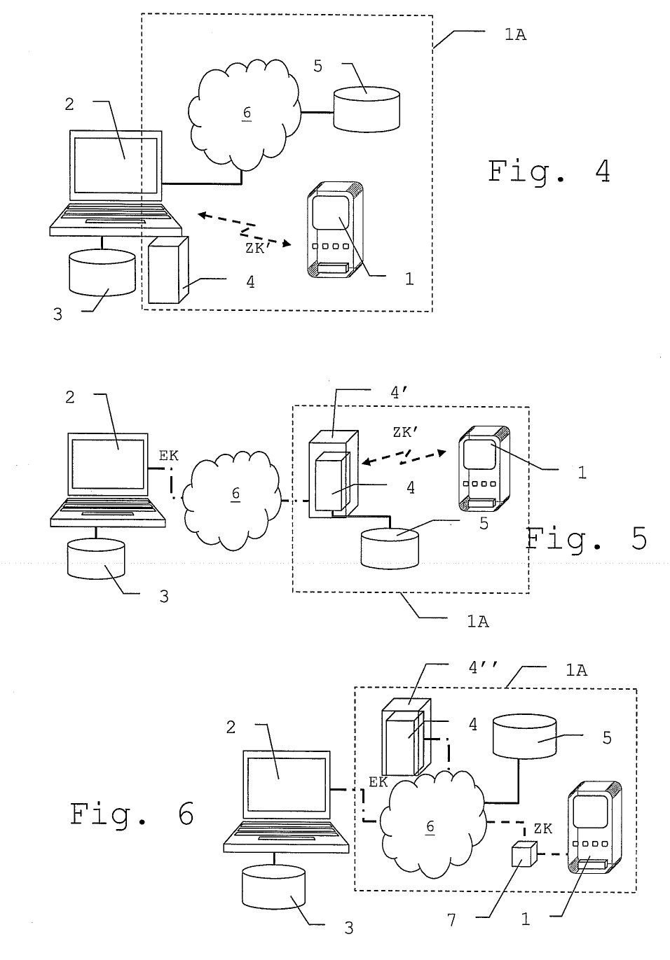

FIG. 4 a schematic representation of a second embodiment of the method of communication according to the invention;

FIG. 5 a schematic representation of a third embodiment of the method of communication according to the invention;

FIG. 6 a schematic representation of a fourth embodiment of the method of communication according to the invention;

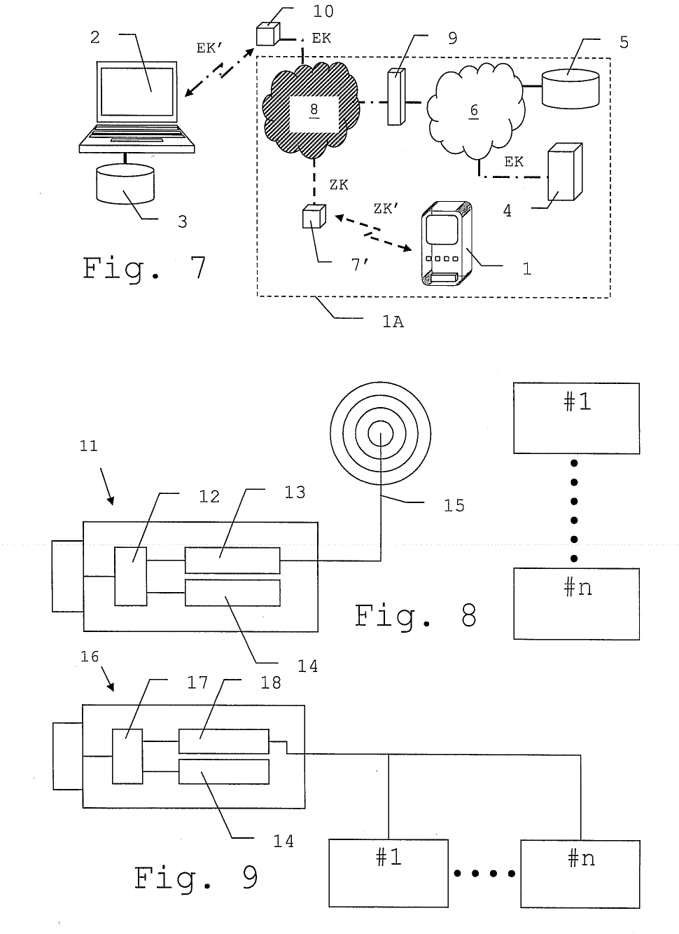

FIG. 7 a schematic representation of a fifth embodiment of the method of communication according to the invention;

FIG. 8 a schematic representation of a sixth embodiment of the method of communication according to the invention; and

FIG. 9 a schematic representation of a seventh embodiment of the method of communication according to the invention.

FIG. 1 explains the basic principle of the method of communication according to the invention in a schematic representation. For communication with a microdevice 1 designed with restricted system resources, a script-based browser is used as the user interface. It is implemented on a display device 2 so as to represent data from the microdevice 1, the corresponding software being provided without specific adaptations to the microdevice 1, in a storage medium 3 that can be accessed directly or via fast data links by the display device 2. Microdevice 1 and display 2 device can be positioned in space, independently of each other. As a rule, the storage medium is that available at any rate on the device side in display device 2. The script-based browser runs on display device 2, and the data transfer protocols needed for communication are used for data exchange with a middleware 4 via a first communications link EK. For the representation of data from microdevice 1, the script-based browser retrieves files as units of information within a script. Thus, the browser represents a generic software presenting the user interface on display device 2. It is generic in the sense that it is suitable for a great variety of different devices and applications. So-called “scripts” and data files represent the data input for the browser. These embody Content, Structure, and Style of the (more particularly graphic) user interface or user surface. The scripts and data files are text-based at least in part, and can be read by people using a simple text editor, while files that are not text-based, as well as image files exist as certain types of Flash files. Style and structure data are text-based. The software of this interface may be capable of also representing so-called web applications as applications, and of subsequently including the microdevice or its data into a web application.

The middleware 4 provides a file that is specific to microdevice 1, the device assignment occurring via the file designation such as the file name or via the URL. The middleware 4 may be realized as an independent unit having its own hardware, or it may be implemented as software on another platform that is used together with other applications. In this case it has access to a memory 5 that is arranged in the platform or in the hardware of middleware 4 itself or is provided externally via a data link, or both. For the middleware, uniformity and suitability for a number of applications is the aim here, that is, a design that is universal rather than specific to the given microdevice 1, so that according to the invention, more particularly, a single middleware 4 will enable communications with a multitude of different microdevices. Middleware 4 and its functions are specifically kept open for being used with different microdevices 1, each having different memory capabilities and computing rates, all the way down to single-chip microprocessors, and with different types of linkage such as Bluetooth, ZigBee, WiFi, DECT, NFC, RFID, etc. This means that we are talking here about generic software to be installed just once (PC, mobile phone, set-top box), which after its first installation may fetch library updates and/or protocol updates from a central location in the Internet and will not require renewed installation when connecting a new microdevice.

For its part, middleware 4 is connected with the microdevice 1 via a second communications link ZK having a lower data transfer rate than the first communications link, more particularly, lower than 3 Mbps or even as low as 9600 bps, while the computing power and memory of microdevice 1 are smaller than the computing power and memory of the middleware 4, the memory in particular being smaller than 100 kB or at most 32 kB.

The design of the second communications link ZK is the limiting factor, more particularly for communications protocols designed for the use of universal, powerful systems configurations, a situation that holds primarily for solutions based on TCP/IP or HTTP.

The keeping and providing of data required for microdevice 1 are handled via the middleware 4, which also defines the interfaces to the display device 2 and to the browser, so that the browser sees this configuration as a virtual microdevice 1a having higher capabilities.

Data assigned to the microdevice are transferred to display device 2 via middleware 4 when the components cooperate, the data transfer from the microdevice 1 to the middleware 4 being synchronous or asynchronous with the establishment of the communications link. The browser merely retrieves from the script the file that is specific to the microdevice 1. The data to be transferred are adapted by the middleware 4 in the background in such a way that the file is provided as the file that is specific to the microdevice, while for the display device 2, this specific file is recognized from the file designation as applying to microdevice 1, so that a representation by the script-based browser becomes possible and the middleware 4 as middleware for display device 2 defines the functional interface to microdevice 1. Apart from retrieving a single file that could for instance contain the data of microdevice 1 that are loaded down asynchronously via the slow second communications link, more complicated data structures may also be provided, but are embodied in a single file on the browser side, more particularly by establishing a web server data structure consisting of only one default file and one zipped file, the latter containing script files, so that the middleware 4 when responding to an inquiry of display device 1 to the microdevice, performs an automatic retrieval and unzips the zipped file.

The function of middleware 4, to unzip file content and have the content ready as separate files for corresponding browser inquiries, may extend to individual files (such as “device.zip”, “devauto.zip”), to entire groups of files (e.g., all files with the extension zip), or to files that can be recognized from a corresponding header line (e.g., with “content encoding:gzip” in the header). This function can be performed for one or several files automatically when a new microdevice 1 is connected and recognized, without waiting for a corresponding browser request (for instance, “device.zip” is requested independently by the middleware 4 from microdevice 1 after this has been connected, and when present, the content is unzipped and cached). Since an identification is not present in the file “device.zip”, this procedure will have to be carried out whenever microdevice 4 is reconnected.

If now files containing a unique identification are found in a file such as device.zip that has been unzipped automatically by middleware 4, then these files will—as soon as requested—be stored in a permanent intermediate memory for uniquely identified files. If ONLY such uniquely identified files are present in the unzipped file, then the request and the automatic unzipping may be omitted, and microdevice 1 will be connected more rapidly. Such a mechanism can be implemented purely script-based in JavaScript: at first a script that should be loaded and is uniquely designated by its file name, and that is present, e.g., in device.zip, is requested. If not found, then device.zip will be requested separately, its content automatically unpacked, and sent to intermediate storage, so that the above file may be requested once more, now successfully. If found, the loading of device.zip can be omitted, etc.

While they are adapted, the data to be transferred may also be supplemented, in which case the middle ware 4 may retrieve the supplements from a storage unit 5. Also, the middleware 4 may simplify the data transfer protocol for microdevice 1, particularly by reducing it to a subset of the hypertext transfer protocol, and/or convert the data to be transferred, more particularly by data compression or data decompression.

File designations that may be used are the file names or a URL, while a hash value may also be included into the file name or into a corresponding URL.

Basically in the same way, data can be transferred from display device 2 via the middleware 4 to the microdevice 1. For communications that are not limited to given localities, it will be possible to realize the first and/or second communications links EK, ZK, advantageously via the Internet. On principle, however, the first and/or second communications links EK, ZK can be realized in any common way, via wire, optical connections, or various wireless or cableless connections. Also, display device 2 may serve to include functionalities of microdevice 1 in applications, as web applications in the Internet.

The retrieval of data by the browser of the user interface and the functioning of middleware 4 are illustrated in FIG. 2. When working through a script SK (e.g., the so-called default files “/index.html” or “/” stored directly in the microdevice), display device 2 will call a file designation recorded there, for instance a file name or the Internet address or URL associated with the middleware, as will be explained in greater detail below. Thus, access occurs to a file provided via middleware 4. This file is adapted and possibly supplemented in such a way by the middleware 4 that a representation or processing by the browser on display device 2 becomes possible. All required steps are handled in the background, so that one achieves the character of a virtual microdevice. In this example, the middleware provides a file combining contributions or contents from three different sources. On the one hand, the middleware 4 retrieves cache data A possibly kept in a cache 4A and retained from earlier communications with the microdevice 1. Files not available there, or data that can only be provided by microdevice 1, are added by loading them down as device data B from the microdevice 1, or where possible from external sources, while completing them, e.g., with supplementary files C loaded down from an external memory 5.

The middleware 4 takes care of all required activities, such as the establishment of communication links and the transfer of data, compression and decompression of files, etc. What the display device 2 sees, to the contrary, is merely an access or retrieval of the file listed in the script that is possible via its file designation.

Data caching that occurs in the middleware 4 as a buffering or caching for microdevice 1 can be realized in very different ways, while three special variants are more particularly feasible according to the invention.
(1) “Standard Library” File Caching. This is a mechanism for files not or no longer stored in microdevices but still used or useful for files of a microdevice 1. For this reason, it concerns files known and defined at the time of installation, comprising standard JavaScript libraries or company logos for instance. Examples of such JavaScript files are rico.js or prototype.js taking up about 70 to 100 kB of memory, which would be in excess of the storage space available in many microdevices. These files may first be optimized by removing characters that are not needed, such as tabulator characters or spaces, in order to minimize storage requirements and guarantee data integrity. Then the hash value of the file including file name and file type extension can be calculated, known algorithms such as SHA1 being available for this calculation. This hash value can then be added to the file name in a customary code, such as Base64 or HEX code. As a result, the file has a designation that includes the hash value, so that a well defined, and globally unique referencing and integrity check is possible.
   a. Example for rico.js: We assume that the SHA1 hash value of the file rico.js (inclusive of its file name and file type extension at the start of the file, and of its content, but without the “SHA-1= . . . ” supplement of the file name that is added later) is for instance given by 556c445491f77f4ab36a17108e5455629483991d″. The middleware 4 may then use the file name “rico.js-SHA-1=556c445491f77f4ab36a17108e5455629483991d” for a file that is stored and possibly transferred to the browser without the necessity of requesting a file name from the microdevice. This means that the hashed file name is defined as follows: <original file name +extension>+“SHA1=”+<hash value of the file content including file name and extension according to the SHA1 algorithm, coded in Base64>.
   b. The middleware 4 maintains its own list of files that can be provided.
   c. The middleware 4 can update or supplement its own holdings of library files via a LAN or Internet link, so that even files that have become available after the time of installation can be supplemented.
   d. The middleware 4 can provide company logos or graphics, for example those of intermediate-size or large companies interested in providing a rapid, optically pleasing, and individualized reminder of their own presence, even though the microdevice itself will be unable to store such graphics.
   e. In this case, using a hash value in the file designation is advantageous insofar as the middleware 4 will be able to find out whether it is worthwhile checking whether the file is held in cache, insofar as other files in this format normally do not have designations of such a length. Typical SHA1 values have a length of 30 bytes when Base64-coded, or of 40 bytes when hexcoded.
(2) Long-term caching. This caching mechanism concerns files actually stored in the microdevice 1, and downloaded when the file was needed for the first time. Subsequently, this file is stored or kept ready in the middleware 4, so that the corresponding inquiries can be answered without data transfer via the slow second communications link ZK. Even in this case it is recommended to use a hashing mechanism, so as to make sure that an inquiry concerning the name of a file is unambiguous and can be answered without error or mix-up. The file thus kept in intermediate storage is NOT associated with a specific microdevice or specific URL, contrary to the usual browser caching mechanism.
(3) Short-term caching. The third caching mechanism helps accelerating the response behavior of microdevice 1 with respect to regularly used STATIC files such as style files, HTML files, .js files, etc. For repeated use, these are kept in the short-term cache. In this context, short-term cache signifies that after a certain time or after a particular event such as interruption or termination of data transfer from this device, the cache is liberated or overwritten. A hashing mechanism is not needed here. Short-term caching can be controlled via the file extensions (.html, js, .css files are handled as static files) or via the http entry “HTTP . . . expires:” described above that precedes the data content proper, for a short-term caching with a time limit even with files having a dynamic content that are not static.
(4) Files not to be cached. This refers to files having variable content, such as server-side includes (SSIs), hence are not static and will undergo dynamic alteration by the microdevice 1 prior to being transmitted to the requesting browser.

In the prior art, to the contrary, caching or buffering occurs differently.
(1) The caching of files retrieved by the browser in the Internet or from an Internet server is controlled on the basis of HTTP entries in the HTTP header. For instance, the entry: “expires: Fri, 30 Oct. 1998 14:19:41 GMT<CR><LF>” exists. Depending on this entry, the browser will interpret the file as expired, and will not cache it, or it will cashe it up to the date given, and retrieve it from that memory without sending the request into the Internet The browser caches files together with a specific URL that is the origin of that file. It is an impediment to use that the caching behavior of browsers may be turned on and off by users, and that browsers from different manufacturers behave differently.
(2) A hash-value-based caching has been defined by the W3 consortium. This is an extension of the HTTP protocol, and thus unfit for microdevices. In their approach, the hash value (“check sum”) is provided in one of the HTTP lines or in metadata. For this reason, a request asking for such a file is more complex, since the content of header lines must be specified explicitly, and not merely the file name request itself, or such a request is not at all possible (HTML). On the web server, the file is stored under its name, while the unique identification is once more stored in the metadata or must be computed. A http header line could for instance be. “Content-ID: urn:sha:7afd . . . <CR><LF>”.

According to the invention, it is a particular feature that the unique identification as a file to be cached is given in the file name or file designation itself, that is, by stating the hash value. Metadata are not needed. The specific syntax used for this identification may take different forms, the decisive point being that this identification is contained, not in one of the HTTP header lines but in the file designation itself, e.g., in the file name or in the requested URL, thus, it is automatically contained in a href or src indication of a HTML or JavaScript file, is transmitted across all proxies, and will even arrive in this unambiguous form at the microdevice if the request could not be answered by a cache memory. It is the purpose of this approach that a specific file (having a unique identification) is downloaded exactly once, is stored in the cache for all subsequent requests of exactly this file, and is retrieved from there, regardless of the browser that happens to be opened, and regardless of the browser's own specific cache setting, also regardless of the device to which the request has been addressed, and of its URL A file once cached, for this reason is available to other devices as well, which makes sense particularly in the case of standard scripts.

It is simple here to install the caching mechanism:
(1) Implementation in a middleware 4 running on a PC or device where the browser used to represent the scripts is running as well, as shown for instance in FIG. 3 (when programming according to the above specification, in the last analysis, for any request a check must only be made whether, according to syntax specification, a unique identification “—SHA-1= . . . ” is present—if so, searching in the cache, if not, forwarding the request and/or inquiring at a specified online location).
(2) Implementation in a middleware 4 set up in a router through which a microdevice 1 is attached to the Internet Commonly, such routers have distinctly lower computing power than a modern PC. In view of the simple caching mechanism, the caching according to the invention may be implemented and operated efficiently even in this case.
(3) Implementation in an online web server representing a proxy for a specific microdevice 1, and forwarding to the (registered) microdevice 1 all those requests that were not unambiguously identified, or were found, either in the cache of the online web server itself or at an online location specified to that end.

Owing to the unique identification stating the hash value in the file name, files become globally unique. Their caching need no longer be assigned to a specific URL, nor to any specific microdevice 1. One or several online locations may then be designated as central storage locations for files to be cached, which makes sense particularly in the case of standard library files (e.g., JavaScript standard files).

Neither the browser nor a router or web server (including those of the microdevices 1) need to be altered, since we are dealing here with “normal” file requests without any change of the metadata or HTTP header. In the web server, the file is stored under its file name, which contains the unique identification. A separate processing of a unique identification as additional information (such as metadata) is superfluous. This makes the approach suitable for microdevices 1. It must merely be required that somewhere along the data transfer path between the browser or first computing unit 2 and the microdevice 1, a caching proxy or middleware 4 be provided, for instance just in front of the microdevice (middleware), at the router (middleware as “embedded middleware”), or online.

However, a file will not necessarily contain a unique identification, which is true for files having dynamic content.

The caching proxy or the second computing unit 4 where this caching mechanism has been implemented, automatically exercises a cleaning action: if the hash value does not correspond to the value computed from the content, then the file is regarded as a false file that can or should be erased from the cache. This secures the integrity of file content: a data alteration attack will have the effect that the file content will not pass the check, and thus its content will not be delivered to the browser. This check could be omitted in certain cases, e.g., in purely internal networks not having any connection to other, external networks.

It is an advantage having file names which in addition provide an indication as to the time of file creation. A date marker can be used to enable automatic updating of the local library. An automatic update may for instance be planned for each first of the month. A date marker also enhances legibility for the human eye, since-pure hash values are less meaningful and a search or examination via date indications is easier. Files to be loaded anew may then be identified via their date and loaded automatically.

The middleware may regularly and/or repeatedly send a request to the microdevice 1, and analyse its response behavior. Such a request may for instance merely concern the header of the index.html file and use the command “HEAD<SP>index.html”. From a correct and timely response of microdevice 1, it can then be concluded that the second communications link ZK is in good order. The response to any HEAD request made in a very low layer of the protocol will be restricted to the EOF character. In this case the protocol does not include any HTTP-like headers that would be transmitted by the microdevice 1 itself, but the middleware 4 supplements the corresponding HTTP header data and returns the HTTP request back to the requesting browser or display device 2, together with the associated header.

Instead of sending its own HEAD request, the middleware 4 may also monitor the link by monitoring the requests of the browser directed to the different microdevices 1, so that it can be established whether or not a functioning link exists. Thus, at times when requests are directed from the browser to the microdevice 1, a separate HEAD request initiated by the middleware 4 need not be made for a certain length of time.

It may be assumed that in the future, new data transfer protocols and/or new communications interfaces will be available as a standard in display devices. These will be added successively, so that it will be meaningful to plan for a possibility of flexible updates by a central place in the Internet during operation of the middleware 4. This can for instance be realized by writing parts of the software for middleware 4 in a programming language that admits a later addition of code. This is possible, for instance, in the case of Python. Here, code may be added later or currently (dynamically), e.g., by downloading from a central place in the Internet, and then executed.

When connecting a new microdevice 1 to the display device, then it will either be recognized or the user must tell the middleware 4 which product out of a selection of products it is. The middleware will then fetch the appropriate code and execute it. Subsequently, this code is included into the list of added codes that have been used up to that point, and may or should then find regular application when scanning connections automatically.

In the following, examples of microdevices 1 will be set forth where the method of communication according to the invention may be applied.
Product example: 8-bit microcontroller attached to a PC or other browser display device

Small microprocesses are used in a multitude of applications in private and professional life while they are not perceived as electronic systems having such a complexity. They are found in domestic appliances, in simple measuring devices, in vehicles, chip cards, watches, heating controls, beverage dispensers, etc., that is, in nearly all electronic devices. Devices containing such microprocessors often have an operating surface that is of very restricted use, and non-intuitive, and that differs between devices in its design. With the method according to the invention, any such device when connected is open to user-friendly operation and setting via a display device that has browser capability.

A simple first example is that of using a Bluetooth module for an automatic door opener where the module (without any other microprocessor) handles the full management of several users authorized for access, and their connection data via Bluetooth (mobile phone), and mails Ajax pages to the browser of the mobile phone of such a user via Bluetooth. A simple door-opening function is realized via a relay that is attached and controlled by the module, and powers the automatic door opener.

The RSSI function of commercial Bluetooth modules and chips can also be used, specifically for initiating distance-dependent actions, such as the opening of a door in the above example, or the establishment of a connection.

A further example is a SmartCard or JavaCard used as web server. A SmartCard or device with integrated SmartCard chip contains a “single-chip” microprocessor capable of providing the computing power of a small calculator and a storage capacity of 100 kB or more. This is not enough for realizing complete Internet protocols or HTTP protocols (IP, TCP, HTTP), but enough for a connection within the scope of the method according to the invention. Apart from that, SmartCard chips are specifically designed as a “secure elements”, since they themselves are able to generate and store key data in a secure manner, while access to this key is far more difficult than on other microchips. Examples are the chips of the SmartMX family of NXP.

A simple file server that evaluates GET requests and answers them by returning the corresponding file as a byte sequence, and may also evaluate and perform an assignment of variables in accordance with the extension of the GET request (after the ‘?’), needs a memory of about 5-10 kB, and it is relatively easy, therefore, to accommodate it on such a chip together with applications software that may also be needed. This very limited memory is large enough to embed the following functions.

The transfer rate from the SmartCard or SmartCard chip to the corresponding partner device may also be limited. In RFID, depending on the reader this may be some 10 kbps, and attain about 400 kbps in NFC, but electromagnetic effects of the environment may depress these rates. This is too low if one wants to transfer the contents of voluminous document pages rapidly to a display device without waiting times for the user that are beyond the downloading times common in the Internet.

This implies that even in this scenario, the method of communication according to the invention can be used to provide the connection to the microdevice 1, while file contents may undergo intermediate storage in a cache as specified by the invention.

JavaCard is a particular embodiment of SmartCards where applications written in the Java programming language (JavaCard applets) may be loaded onto these SmartCards later, after they have already been issued to a user. In this way such a chip card becomes a card that may serve multiple applications. For instance, one and the same card may be used for obtaining cash from an automatic teller machine, and for authentication when entering a building. This multiple applicability of JavaCards has been greeted with hesitation by industry, the reason supposedly being that Corporate Identity as seen by applications suppliers (e.g., a bank) is too indistinct when the function of drawing cash from a bank account as an example could be placed on somebody else's JavaCard. The representation of Corporate Identity will be improved when, as described above, presentation contents are kept ready for every application in the file memory of the JavaCard. Thus, every applications supplier (bank, supplier of technology for building access) could put his presentation including logo, styles, etc. onto the JavaCard to make sure that this card will be presented to the user on a display device according to the supplier's ideas.

When implemented for instance in a SmartCard chip or JavaCard chip, this web server technology can also provide sophisticated operating surfaces tuned to the particular user. The microdevice 1 and/or the middleware 4 learn what the particular user group is, and may then present operating pages that have been individualized, and maybe even stored, for this particular user group or user. For instance, a microdevice 1 could present itself in different ways to a service technician, an administrator, a senior citizen or a young person that has logged in.

The concept described above, of caching certain data, not in the microdevice 1 but in a middleware 4, makes it possible to supply memory-intensive files such as company logos, graphics, library files more rapidly (ideally, even instantaneously) from the middleware 4 to the browser. It thus becomes possible to accommodate attractive representation pages including graphics content that matches the Ideas of Corporate Identity, even on small chips such as SmartCard chips.

A JavaCard chip normally lacks input/output pins, it is made as a pure server device, the main reason possibly being that it would constitute a security risk to provide the JavaCard chip and the reloadable applications running on it, with access to the I/O pins. This risk can only be managed in complex arrangements (such as a fixed, predefined local key for I/O access). In the following we present a simple and secure arrangement enabling a JavaCard to be incorporated into Hardware containing I/O pins which from the outside cannot be addressed, or only with an excessive effort. This is managed by connecting in series a simple logic chip or a simple logic function that will only convey all 7-bit data to the chip card, all other data being discarded since the 8th bit is not set. In this way only ASCII data and/or UTF-7-encoded data (or similar data) will reach the SmartCard-Chip. This will suffice, since the GET command defined above meets this requirement. At the same time, the SmartCard by definition may return ONLY 7-BIT DATA as a file response, that is, with the 8th bit not set. This does not constitute a limitation when using the protocol example given above, since again, without limiting the function, pure ASCII characters can be included. Now one can define that any data stream having the 8th bit set, as an instruction for the logic component implies that it should set its I/O pins accordingly, or read and answer with the 8th bit set Attention should be paid, however, to watch out for the peculiarities of the byte-based communication of SmartCard chips according to ISO 7816, and to recognize so-called APDUs and fixed commands based on standards, prior to setting an I/O pin. It is proposed to define a column of more than three consecutive bytes, all having the 8th bit set, as valid instruction for setting or reading an I/O pin.

In the specific embodiment, data communication for XML or json-based control of the microdevice from the display device—with browser via middleware 4—to the microdevice 1 is accomplished through the response to GET requests, where said response contains SSIs.

An example: a microdevice 1 driving a relay, and thus knowing a variable containing the condition of the relay (“REL”), may transmit the condition of the relay to the browser by means of the following .xml file, after the browser has requested the file REL.xml (transmitted “GET /REL.xml”):

Content of REL.xml file:

```
  <?xml version=“1.0” encoding=“UTF-8” standalone=“yes” ?>
- <REL>
  <value><!--#echo var=“REL” --></value>
  <true>ON</true>
  <false>OFF</false>
  </REL>
```

Here, the chain of characters <l-#echo var=“REL”-> is the SSI tag referencing the variable REL. In the case of REL=1, the requesting browser will obtain the following response:

```
  <?xml version=“1.0” encoding=“UTF-8” standalone=“yes” ?>
- <REL>
  <value>1</value>
  <true>ON</true>
  <false>OFF</false>
</REL>
```

This file is readily evaluated with current browser language (JavaScript), and the text “ON” may then be displayed at a predefined position well visible to the user.

Content of a .json file “REL.json” which, as an example, dynamically includes the variables REL and DEVNAME:

{
“REL”:“<!--#include file=“REL”-->”,
“DEVNAME”:“<!--#include file=“DEVNAME”-->”
}

When this file REL.json is requested, the microdevice then returns the following data content (as an example) when the relay is ON:

{
“REL”:“1”,
“DEVNAME”;“Relais_Name”
}

This dynamic file content can by compiled advantageously, by direct call of a function in the firmware, rather than via SSI. Then REL-json will not be a file of the file system but a code portion contained in the firmware and providing, in the final analysis, the answer desired.

The .json or .xml-based contents presented above have referred to a data presentation in known format. In the case of .cgi files, this is not necessarily so. For this reason, this file extension is used to characterize other dynamic contents that are not presented in known JSON or XML syntax.

In this way it becomes possible—while keeping the usual rules for file extensions—to build self-executing or self-representing, widget-like script contents with dynamic contents into a microdevice.

As a further application example, a system is shown in the following that makes it possible to simulate Ajax scripts on a web server that has been set specifically for this job but is otherwise a standard web server, such as the widely distributed Apache web server or a trimmed down and more open version such as Xampp.

This system consists of
a specially selected syntax for the SSIs,
an interpreter for assignment of the variables that is based on PHP server language, these assignments being attached to a GET string, and in the specific example contained in the file dev.php.
a simulator web server, that is, a web server containing particular settings and used for simulating the scripts intended for the microdevice 1.

The following simple example is intended to provide illustration, and is limited to few variables, such as the variable REL far “condition of relay”.

It is the particular aim that scripts designed for microdevice 1 are run on the simulation web server without any change, that is, without changes in these files, and are tested via the browser, without having to use the hardware of microdevice 1. Here the image of the variables, that is, the set of all variables and associated values, is provided to the scripts running in the browser in the same manner as would be the case with scripts coming from microdevice 1.

In this way one can test and simulate scripts intended for microdevice 1, extensively prior to loading them into the microdevice 1, as this loading may turn out to be a more or less complicated process and above all requires one to have the microdevice 1 as hardware. This should be done, not merely in view of the appearance of script design in the browser but also in view of the functionality resting on particular values of the variables, and in view of calculations and recalculations possibly occurring in the browser, and of displays appearing on the browser. The simulation is an exact one to-one simulation. A merely internal functionality that may occur in microdevice 1 may not be simulated, or may not be simulated so simply, because to this end a further device-specific simulation script would have to be devised on the server side. Here, however, the idea is that of running a server-side script (dev.php) that is independent of microdevice 1 and of its functionality and evaluates assignments of variables by the browser/user.

This will be represented for an example where the microdevice Functionality essentially consists in the ability of switching a relay with values REL=0 or REL=1 on and off, a device name exists with the variable DEVNAME, and a PIN exists with the identical variable name. This example will be demonstrated in terms of web server technology PHP. Basically, however, the concept can be transferred to other technologies such as CGI, Perl, Python, etc.

(1) Simulation file(s): A (main) PHP file “dev.php” exists where essentially the device variables are defined and the device functionality is simulated. In it, all device variables are defined as global variables so that they will be available to all other scripts to the extent needed. The names of these variables are kept uniform throughout for the sake of perspicuity.

Function in the simulator: in this simple example, the variables are initialized following the first call, e.g.: REL=1; DEVNAME=AJAXupPHP; PIN=1234. However, this initialization of the variables, may also be contained in a separate ini.php file that has no function at all in microdevice 1. Then prior to each simulation procedure, the file ini.php would have to be called.

This simulation file dev.php further contains any functionality that may exist in microdevice 1, such as internal calculations of values of variables or program runs. In the above example, for instance, the relay after switching on to REL=1 may automatically return to the idle state of REL=0 after a predefined period of time, possibly coupled with an internal time function.

Function in the microdevice 1: no function exists in this respect. The file dev.php is ignored when called with GET, or an empty file is returned. It might contain ini.php, but this should/must not be used by the scripts. In the final analysis, the microdevice 1 can only fill two functions that are managed, i.e., simulated, in the simulator by the PHP surface and by dev.php: on the one hand evaluation of the GET query string and execution of any assignment of variables that may be contained in it, and on the other hand parsing of .php files for the expression <?php echo=REL ?> and replacing this character string by the true value of variable REL, that is, 0 or 1.

Specific execution for dev.php, which parses or interprets any number of assignments of variables separated by “&”, and writes them into specific individual files associated with each value of a variable on the simulation web server. These individual files have a function, only on the simulation server, which is that of inserting the content into the place of a server-side include having the form of <l-#include file=“REL”->. In this way the same effect is attained as in the microdevice 1 while there is no need to change the file. All individual files for variables such as “REL” could in fact also be loaded into the microdevice 1—intentionally or unintentionally—but have no function there. For this reason one may load the entire set of files from the simulation server to microdevice 1 after successful simulation.

Sample File Dev.php:

```
<?php
if(!empty($_GET)){
  foreach($_GET as $gg => $g){
    if($g!=“”){
      $fp = fopen($gg,w);
      ftruncate($fp,0);
      fwrite($fp, $g);
      fclose($fp);
    }
  }
}
?>
```

The content of file “REL” (file name without extension in this specific example) is: 1, when the relay is ON.

The same content comes about when the browser starts a GET request in which the value of 1 is assigned to variable REL. On the server side, the above dev.php takes care that the file “REL” will obtain precisely this content. The corresponding GET request looks as follows, for example: GET dev.php?REL=1.

(2) Assignments of variables: Browser commands with which values of variables are to be changed are communicated in the GET query string from the script running in the browser (that is, after the n), and must be addressed to the dev.php, i.e., a switching of the relay to 1 would be formulated as follows: GET dev.php?REL=1.

Function in the simulator: The php-file thus called evaluates the query string “REL=1” that was addressed to it, and sets the global variable REL to 1. All other scripts when called have access to this variable with its new value of 1.

Function in the microdevice: this ignores the file request for dev.php and merely returns an empty file, that is, merely an EOF or a file with Content Length: 1, depending on the protocol. The GET query string “REL=1” is recognized by the microdevice 1 as command for assignment of a variable, and the variable is set accordingly.

The functions in the simulator and microdevice 1 thus are the same. One merely must adapt the microdevice 1 accordingly, so that it ignores the file request for dev.php and replies with empty content (i.e., only EOF), but interprets and executes assignments of variables contained in the GET query string.

(3) Inclusion of variables, file extensions: the interactive browser function comes about because files requested by the browser from microdevice 1 or from the simulator contain dynamically included values of variables.

The source file contains the character string <?php echo VAR ?>, which is interpreted by the microdevice and also by the php web server where the simulation is supposed to take place, in such a way that instead of this character string the value of the variable is included into the file, and this file is transmitted.

This automatic parsing can be set, both in the microdevice 1 and in the php web server for files with specified extensions or file terminations. This is possible for .php files, but also for any files used elsewhere that contain included values of variables, such as optional .xml, json, .shtml. It is important that these file terminations are set in the same way for the php interpretation in microdevice 1 and in simulation, i.e., in the web server. If this is the case, only for .php, which is often the standard setting of web servers, then pure data files—should they contain dynamically included variables—should also be executed with the termination .php.

(4) Simulator-microdevice-developer interface: A special page can be used to view the current values of the variables during a simulation of developed scripts. This may simply occur in a SHTML file having a refresh time set to a small value. In this case, .shtml must also be set as PHP-parsed file extension. It may also be a .php file simply listing all variables and indicating their values. Beyond that, this portal may also be used to change or enter values of the variables while the simulation is running.

Example No. 1: device.php (“developers device portal”) with the entry: <p>REL=<?php echo REL ?></p> etc.

Example No. 2: device-shtml with the possibility to enter values of variables, output of the current values of the variables (SSIs).

Example No. 3: device.json as file.

(5) Access to the simulation: The whole may run on a web server with PHP functionality, e.g., xampp, running locally or on external, rented web space, e.g., based on an Apache web server with PHP, and hence be available for third parties to have a look Particularly a testing where different browsers such as the Microsoft Internet Explorer (MSIE), Mozilla Firefox (FF), Opera (opera.com), and Browzar (browzar.org) are used, proved to be very important and often has required a “tweaking” of script code until the scripts would run perfectly on all these browsers. Simulation offers the possibility of doing this efficiently, and even in parallel.

(6) Interface between a microdevice developer and an Ajax script web designer in view of an example including a single .json file for a microdevice 1 having a name (DEVNAME), a personal identification number (PIN), and two users with an address (USERx_BDADDR) and a name (USERx_NAME) each:

Content of the file device.json:

```
{
  “variables”:
  [
    {
    “name”: “DEVNAME”,
    “default”: “0”,
    “current”:‘<!--#include file=“DEVNAME” -->’,
    “description”:“Device Name”
    },
    {
    “name”:“PIN”,
    “default”:“10”,
    “current”:‘<!--#include file=“PIN” -->’,
    “description”:“PIN for all users USR1-7 for connecting”
    },
    {
      “name” : “USER0_BDADDR”,
      “default” : “00USR0BDADDR0000”,
      “current” : ‘<!--#include file=“USR0_BDADDR” -->’,
      “description” : “BT Dev Address of this user READ ONLY !”
    },
    {
      “name” : “USER0_NAME”,
      “default” : “HIMMEL”,
      “current” : ‘<!--#include file=“USR0_NAME” -- >’,
      “description” : “Device Name of this user, READ ONLY !”
    },
    {
      “name” : “USER1_BDADDR”,
      “default” : “00USR1BDADDR0000”,
      “current” : ‘<!--#include file=“USR1_BDADDR” -->’,
      “description” : “BT Dev Address of this user, READ ONLY !”
    },
    {
      “name” : “USER1_NAME”,
      “default” : “n.a.”,
      “current” : ‘<!--#include file=“USR1_NAME” -->’,
      “description” : “Device Name of this user, READ ONLY !”
    },
  ]
}
```

Here a format is specified for the developer in which he may enter his microdevice variables that he names or transmits to the web designer, including default values for the purposes of simulation, and including a description. The web designer can include this device.json file at once into the given simulation web server, where for instance a PHP script, e.g., ini.php, will perform an initialization procedure on the basis of this json file where the values of the variables are initialized. The above device.json file at the same time contains all associated SSI variables, and may therefore provide the full picture of the variables to a HTML page or SHTML page or Ajax page available to the developer, so that they may be presented in a clear way.

Using particular settings, the simulation web server can be set in such a way that it will behave just like microdevice 1. It is assumed here that in the simulation, for each variable an associated file is available that contains merely the current value of the variable. The web server setting should more particularly perform a server parsing of SSIs in all those files that contain SSIs, e.g., .shtml files, json files, .xml files, .ssi files, and .inc files. It will also be advantageous to set the server in such a way that .shtml files are recognized by the browser as HTML files, rather than as undefined files, and that they are displayed as such, and not offered automatically for download as is done by some browsers. It will finally be advantageous if the web server will include a line with “expires:”, followed by a date that has already expired, into the HTTP header of all .shtml, .json, .xml, .ssi, and inc files. In this way one makes sure that the browser will not cache these files, that is, will not fetch them from some intermediate memory, but will always request them anew when a script entry requires it.

A further applications example is the inclusion of microdevices 1 via a middleware 4, as web widgets into online web pages. A web widget is understood here as the inclusion of a web page, such as a microdevice surface, into another web page, e.g., online account. It is very easy, basically, using the “iFrame” technology to simultaneously represent in a single HTML page two web pages having different URLs. Two web pages are represented practically independently in well defined frames within a single web page. The problem that arises here is the inability of these two frames to exchange data with each other, a feature implemented for reasons of security into the browser functions. This represents an essential limitation for the method of communication. For the user, it is advantageous if device GUI data can be shifted to the online web page, or if the data of the microdevice 1 can be put to use in another form in the online account, exactly as if the microdevice 1 was part of the online application.

The iFrame method mentioned is not suitable for that. It is not technically possible, moreover, to send an XMLHTTP query to another URL, it can only be sent to the same URL from which the web page currently displayed comes. This is also prohibited by modern browsers for reasons of security. This means, it is not possible in an online web application with the sample URL http://www.onlineapplication.com/index.html, to send an XMLHTTP query to a device having another URL, for instance, http://localhost:10000/index.html.

The first possibility of a solution to this problem is that of asking the middleware 4 to pretend to the browser that a single URL is present, while the individual inquiries, however, are sent either to www.onlineapplication.com or to localhost:10002, depending on the addressee: the online server for the web application or the microdevice locally included via the middleware 4. In this approach to the problem, the middleware 4 represents a single URL for the browser, e.g., http://localhost:10000/. Now all queries may be forwarded automatically without any further protocol statement “http://” to the microdevice 1. The request to http://localhost10000/index.html is passed on as “GET/index.html” to microdevice 1. All queries indicating an online URL using a new protocol statement rather than the file name are then forwarded into the Internet, e.g., http://localhost: 10000/http://www.onlineapplication.com/index.html. The middleware 4 recognizes such an inquiry by seeing that instead of the expected file name, a protocol statement including “:” D follows, so that this cannot be a file name. Thus, for the browser, both URLs, the microdevice URL and the online application URL, appear as one and the same current browser URL, that is, in the present example http://localhost:10000/.

A further possibility for including microdevices 1 as web widgets by means of middleware 4 is given by the JS or JavaScript method. As an alternative to the problem approach presented above, a possibility exists to gain direct access to the microdevice 1 from an online URL that is the current browser URL, even without extending the functions of the middleware 4, viz., using the normal HTML entry of a JavaScript source being requested.

This entry is for example given by: script type=“text/javascript” src=“http://localhost:10000/devicewidgetscriptexample.js”>.

Here the browsers apply no URL check, and send this query even to URLs not matching the current browser URL. The same principle is applied as well by Google Analytics.

For the method of communication according to the invention, however, the hurdle still exists that the data content of a file requested in this way cannot be viewed by the browser—the browser has no access to the individual bytes of the file. Only preestablished browser functions can be used, such as display in the form of an image or execution as a JavaScript file. The latter may be used by filing JavaScript scripts that can be executed in the device, as a kind of web widget code, as it were, and these can then be executed by simply requesting this JavaScript file via a uniform command from an online web applications web page.

FIG. 3 is a schematic representation of a first embodiment of the method of communication according to the invention. In this example, the middleware 4 is implemented in the hardware of the display device 2, that is, both components use the same computer, so that the middleware is realized purely on the software side. An alternative is that of implementing the middleware 4 in a USB adapter that may then be attached to a USB port of display device 2, for instance in the meaning of a “software cable”.

A variant of this solution is shown in FIG. 4 for a second embodiment of the method of communication according to the invention where the middleware uses the Internet 6 for access to memory 5, which will for instance allow the data stock originally installed to be continuously or periodically updated or supplemented, as described above. Here the second communications link ZK′ is realized as a wireless radio system. Even in this embodiment the full system consisting of middleware 4, microdevice 1, and memory 5 with intervening Internet connections, to the browser layer looks like a virtual microdevice 1a having higher power.

FIG. 5 explains a third embodiment of the method of communication according to the invention where display device 2 accesses the middleware 4 via the Internet 6, the middleware thus being implemented on a computer independent of the display device. This computer may for instance be a router 4, having its second communications link ZK′ to the microdevice realized as a wireless link. The router with middleware 4 together with memory 5 and microdevice 1 sum up for the browser as the virtual microdevice 1, for which the interface is shown. A potential specific embodiment would include a router 4′ as platform for a middleware 4 with AMD LX800 or ARM9 processor and Linux-OS, and a clock frequency of 150 to 500 MHz, that is, still distinctly higher than the clock frequencies of 1 to 20 MHz common for small microcontrollers in microdevices 1.

A fourth embodiment of the method of communication according to the invention is presented schematically in FIG. 6, where the communications between all components are realized via the Internet 6, that is, the first and second communications links EK, ZK use the Internet 6 at least in part. Specifically, the microdevice 1 may for instance be connected via a cable link, e.g., RS232, to a network access point 7 without particular functions, this network access point 7 merely providing attachment to the Internet, and thus the link to a server 4″ on which the middleware is realized. The user interface realized on the side of the browser appears on a separate display device 2 also linked via Internet 6 to the server 4″ and its middleware 4. Basically, instead of the Internet 6 one may also use other communications networks, e.g., merely local parts of the Internet or an intranet. Data transfer traffic between server 4″ and display device 2 is higher on account of caching and of the middleware function realized on the server, while between server 4″ and the microdevice 1, data communication can be limited to a minimum. This arrangement is of particular interest when the network access point 7 is left without free resources with which to realize a middleware 4, or when this point should be particularly economic and hence low in resources. This middleware 4 can be realized on server 4″, specifically for instance in a PHP script.

FIG. 7 is a schematic representation of a fifth embodiment of the method of communication according to the invention, including an intranet 8 as an additional communications network. Now the virtual microdevice 1a, analogously to FIG. 6, consists of microdevice 1 with network access point 7′, the microdevice 1 here being attached via a wireless link, e.g., ZigBee, and of the further components communicating with each other via intranet 8 and Internet 6. As a mobile device with browser, display device 2 here is attached via WLAN as the first communications link EK′ and via intranet 8 to the Internet 6. In this representation, memory 5 and middleware 4 can be attached via a firewall 9. In this embodiment, both the first and the second communications links EK, EK′, ZK, ZK′ include wireless and wired portions as well as portions taken through communications networks. In both cases, the power of the link is always determined by the weakest portion.

FIGS. 8 and 9 are schematic representations of a sixth and seventh embodiment of the method of communication according to the invention.

The concept of a software cable can be extended to router devices. FIG. 8 here shows how a “USB stick adapter” like a wireless USB stick 11 according to the invention can be realized, e.g., by means of ZigBee, while FIG. 9 shows such a realization for hard-wired embodiments of a USB adapter 16, e.g., according to RS485. The connections to microdevices #1 . . . #n are realized via an antenna 15 or a cable. Next to hubs 12 and 17 and to the specific adapter modules 13 and 18 proper, one always finds a memory component 14 containing the middleware. When plugging into a PC, this middleware is executed automatically or offered for execution. This middleware in turn recognizes the USB ZigBee or USB RS485 module as a microdevice according to the invention, which in this case functions as router module. It is a central function of the router module to recognize the microdevices #1 . . . #n that have been attached, and list them.

An exemplary data format for such a device list looks as follows:

Contents of DEVLIST.json:

{ “DEVLIST”:
[
[ “<DEVADDR>”, “<DEVNAME>”,
“<DEVTYPE>”, “<DEVSTATUS>”, null (or
“DEVLIST.json” if router device) ], // note: 1st device
[ “<DEVADDR>”, “<DEVNAME>”,
“<DEVTYPE>”, “<DEVSTATUS>”, null (or
“DEVLIST.json” if router device)], // note: 2nd device
...
// note: further devices separated by commas
[ “<DEVADDR>”, “<DEVNAME>”,
“<DEVTYPE>”, “<DEVSTATUS>”, null (or
“DEVLIST.json” if router device) ] // note: last device
]
}

Here, DEVADDR is a unique terminal device identification, DEVNAME is the legible device name, DEVTYPE is an indication of device type, possibly given in a globally unique way, and in the last column the indications of DEVLIST.json (or another directory file) are an indication that this terminal device is once again a router device with device directory.

A middleware that is executed recognizes when seeing such a device directory such as the DEVLIST.json shown above that it has to do with a router microdevice to which further terminal devices are attached in turn. Communication with a terminal device may now be established by sending a request or inquiry to the router microdevice that in front of the file name includes the (unique) identification of the terminal device, such as DEVADDR. The request then looks as follows: GET/[DEVADDR1]/index.html, when requesting the index.html of the first terminal device. Here, [DEVADDR1] stands for the unique device address of the first terminal device connected.

The router microdevice may have its own GUI (though this is not compulsory), in that it will respond to an inquiry GET/with a corresponding content (default file) that can be represented in the browser. Then even this microdevice may be operated by a user, and settings may for instance be edited without the need for own software.

The communications between the individual terminal devices #1 . . . #n may again follow the protocol according to the invention that has been described for serial transmission pathways, but it may be a protocol, more particularly when working with ZigBee, that maps the HTTP-like request and response messages onto transfer packages, in this case onto ZigBee packages.

It is not compulsory that the above microdevices are only based on ZigBee or RS485. We talk about exemplary implementations. More particular, any wireless or cable-bound transmission methods can be used to link one or more than one terminal device to a USB port, such as UWB, Bluetooth, Wibree, RflD, USB (direct), RS422, field buses such as Profibus, etc, etc.

In the case of “USB”, too, we may have to do with other buses customarily found in PC, such as PCI, Mini-PCI, LPC, I2C, etc.

The middleware here contained in memory component 14 on the router microdevice, preferably is a generic middleware not oriented toward a specific function of associated minidevices or of router microdevices having further terminal devices. This means that at any later point in time a terminal device having a new functionality may be attached, and this functionality is automatically available to the user since the corresponding GUI scripts are contained in the device or are unambiguously referenced. Thus, for the distribution and maintenance of particular applications/GUI software, the administrative effort is nil or small, and current device innovations can be introduced in a simple way into existing device systems.

The system-specific examples notwithstanding, the method is fundamentally useful also for other forms of data holding and communication. The design of data formats and the logical and physical maintenance of the data in particular can be adapted by one skilled in the art, without any problems to different systems.

1. Method of communication for the transfer of data for an electronic microdevice (1),
with
a user interface realized on a display device (2) for the representation of data from the microdevice (1) by means of a script-based browser retrieving files as units of information from within a script, and by means of a data transfer protocol, where microdevice (1) and display device (2) can be positioned locally independently of each other,
a middleware (4) which can be connected,
on the one hand via a first communications link (EK, EK′) with the display device (2) and
on the other hand via a second communications link (ZK, ZK″) with the microdevice (1),
where
the data transfer rate of the second communications link (ZK, ZK′) is lower than that of the first communications link (EK, EK′), and more particularly lower than 3 Mbps, and
computing power and memory of the microdevice (1) are lower than computing power and memory of the middleware (4), the memory in particular being less than 100 kB,
and at least the steps
transfer of data assigned to the microdevice (1), to the display device (2) via the middleware (4), where the data are transmitted from the microdevice to the middleware (4) for transfer, synchronously or asynchronously in advance, wherein
an adaptation of the data to be transferred occurs in such a way that the middleware (4) provides a file that is specific to the microdevice (1) and to the display device (2),
this specific file being assignable to the microdevice (1) by the display device (2) in view of the file designation, so that a processing by means of a script-based browser becomes possible and the middleware (4) defines display device (2) as the functional interface to the microdevice (1).

2. Method of communication according to claim 1, wherein
data to be transferred from the microdevice (1) during adaptation are supplemented by the middleware (4) with further data, these supplements being retrieved by the middleware (4) from a memory unit (5) that is independent of microdevice (1).

3. Method of communication according to claim 1, wherein
the middleware (4) during adaptation simplifies the data transfer protocol for the microdevice (1), particularly by reducing it to a subset of the hypertext transfer protocol.

4. Method of communication according to claim 1, wherein
the middleware (4) during adaptation converts the data to be transmitted, in particular by data compression or data decompression, in order to generate the specific file.

5. Method of communication according to claim 1, wherein
the middleware (4) during adaptation generates data structures adapted with a view to microdevice (1), in particular by setting up a web server data structure consisting of just one default file and one zipped file, the zipped file containing script files such that when answering a request from the display device (2) to the microdevice (1), the middleware (4) automatically retrieves and unzips the zipped file.

6. Method of communication according to claim 1, wherein
the middleware (4) during adaptation undertakes a data caching for microdevice (1).

7. Method of communication according to claim 6, wherein
a hash value is added as file designation to or included in the file name or a corresponding address designation in the Internet (6), so that a well-defined referencing including integrity check is possible.

8. Method of communication according to claim 7, wherein
the hash value is computed from the content of the file including file name and file type extension, and is appended to the file name.

9. Method of communication according to claim 1 wherein
the memory of the microdevice (1) is 32 kB at most, and the data transfer rate in the second communications link (ZK, ZK′) is 9600 bps at most.

10. Method of communication according to claim 1, wherein
data are transferred from the display device (2) to the microdevice (1) via the middleware (4).

11. Method of communication according to claim 1, wherein
the first and/or second communications links (EK, ZK) are realized via the Internet.

12. Method of communication according to claim 1 wherein
the middleware (4) is implemented in the display device (2).

13. Method of communication according to claim 1, wherein
the middleware (4) is implemented in a UBS adapter.

14. Method of communication according to claim 1, wherein
an inclusion of functionalities of the microdevice (1) into applications in the Internet (6) is brought about by the display device (2).

15. Computer program product with program code that is stored on a machine-readable support or embodied by an electromagnetic wave, for carrying out the method according to claim 1, in particular when running the program on a computer.

16. Data structure product for carrying out the method according to claim 5, comprising one default file and one zipped file, the zipped file containing script files such that when answering a request from the display device (2) to the microdevice (1), the middleware (4) by retrieving the default file automatically retrieves and unzips the zipped file.
